(19) United States
(12) Patent Application Publication
(10) Pub. No.: US 2024/0330405 A1
(43) Pub. Date: Oct. 3, 2024

(54) INFORMATION PROCESSING DEVICE, INFORMATION PROCESSING METHOD, AND COMPUTER-READABLE STORAGE MEDIUM

(71) Applicant: HONDA MOTOR CO., LTD., Tokyo (JP)

(72) Inventors: Sho Nakajima, Wako-shi (JP); Atsushi Yamamoto, Wako-shi (JP); Jun Okano, Wako-shi (JP)

(21) Appl. No.: 18/582,709

(22) Filed: Feb. 21, 2024

(30) Foreign Application Priority Data
Mar. 31, 2023 (CN) 202310340462.7

(51) Int. Cl. G06F 17/18

(52) U.S. Cl. CPC G06F 17/18

(57) ABSTRACT

An information processing method executed by an information processing device includes: generating a new individual by changing a value of part of explanatory variables of an individual selected with a first probability from current generation data, which has n individuals (n is an integer of two or more) and in which each individual is an explanatory variable group having a plurality of explanatory variables, to a target value based on a value of a corresponding explanatory variable of another individual; generating a new individual by changing a value of part of explanatory variables of an individual selected with a second probability from the current generation data to another value; and selecting n individuals of next generation data from the n individuals and the generated individual based on a degree of fitness calculated from an explanatory variable group for each individual, wherein the explanatory variable is set to take a value within a predetermined range determined in advance.

### CROSS-REFERENCE TO RELATED APPLICATION

Priority is claimed on Chinese Patent Application No. 202310340462.7, filed on Mar. 31, 2023, the contents of which are incorporated herein by reference.

### BACKGROUND

### Field of the Invention

The present invention relates to an information processing device, an information processing method, and a computer-readable storage medium.

### Background

Product design can be understood as a multi-objective optimization problem that pursues a plurality of objectives. For example, in battery design, an increase in capacity, an increase in output, a reduction in production cost, and the like are pursued. Evolutionary algorithms are sometimes used in the multi-objective optimization problem. Among the evolutionary algorithms, for example, a non-dominated sorting genetic algorithm (NSGA-II) is sometimes used. As the related art, for example, technologies described in Japanese Unexamined Patent Application, First Publication No. 2011-187056, Japanese Unexamined Patent Application, First Publication No. 2019-191887, Japanese Unexamined Patent Application, First Publication No. 2020-106957, Japanese Patent No. 5235652, and Japanese Patent No. 6918681 are disclosed.

### SUMMARY

When multi-objective optimization is performed using an evolutionary algorithm, the algorithm attempts to calculate a Pareto solution with a higher degree of fitness. For this reason, in product design and the like, explanatory variables that cannot be realized may be output.

One object of aspects of the present invention is to provide an information processing method, an information processing device, and a computer-readable storage medium that calculate a feasible solution.

An information processing method according to a first aspect of the present invention is an information processing method executed by an information processing device, including: generating a new individual by changing a value of part of explanatory variables of an individual selected with a first probability from current generation data, which has n individuals (n is an integer of two or more) and in which each individual is an explanatory variable group having a plurality of explanatory variables, to a target value based on a value of a corresponding explanatory variable of another individual; generating a new individual by changing a value of part of explanatory variables of an individual selected with a second probability from the current generation data to another value; and selecting n individuals of next generation data from the n individuals and the generated individual based on a degree of fitness calculated from an explanatory variable group for each individual, wherein the explanatory variable is set to take a value within a predetermined range determined in advance.

A second aspect is the information processing method according to the first aspect described above, wherein the explanatory variable may take a value within a set range when the explanatory variable is a continuous value, and the explanatory variable may take one of a plurality of candidate values when the explanatory variable is a discrete value.

A third aspect is a computer-readable storage medium that stores a computer program for causing a computer of an information processing device to execute the information processing method of the first aspect described above.

An information processing device according to a fourth aspect of the present invention includes: a storage portion configured to store current generation data which has n individuals (n is an integer of two or more) and in which each individual is an explanatory variable group having a plurality of explanatory variables; and an individual processing portion configured to generate a new individual by changing a value of part of explanatory variables of an individual selected with a first probability from the current generation data to a target value based on a value of a corresponding explanatory variable of another individual, generate a new individual by changing a value of part of explanatory variables of an individual selected with a second probability from the current generation data to another value, and select n individuals of next generation data from the n individuals and the generated individual based on a degree of fitness calculated from an explanatory variable group for each individual, wherein the explanatory variable is set to take a value within a predetermined range determined in advance.

According to the first to fourth aspects, it is possible to calculate a feasible solution.

### BRIEF DESCRIPTION OF THE DRAWINGS

FIG. 1 is a schematic block diagram which shows an example of a functional configuration of an information processing device according to the present embodiment.

FIG. 2 is a schematic block diagram which shows an example of a hardware configuration of the information processing device according to the present embodiment.

FIG. 3 is an overhead view which exemplifies information processing according to the present embodiment.

FIG. 4 is a diagram which exemplifies constraint conditions according to the present embodiment.

FIG. 5 is a flowchart which shows another example of information processing according to the present embodiment.

### DESCRIPTION OF EMBODIMENTS

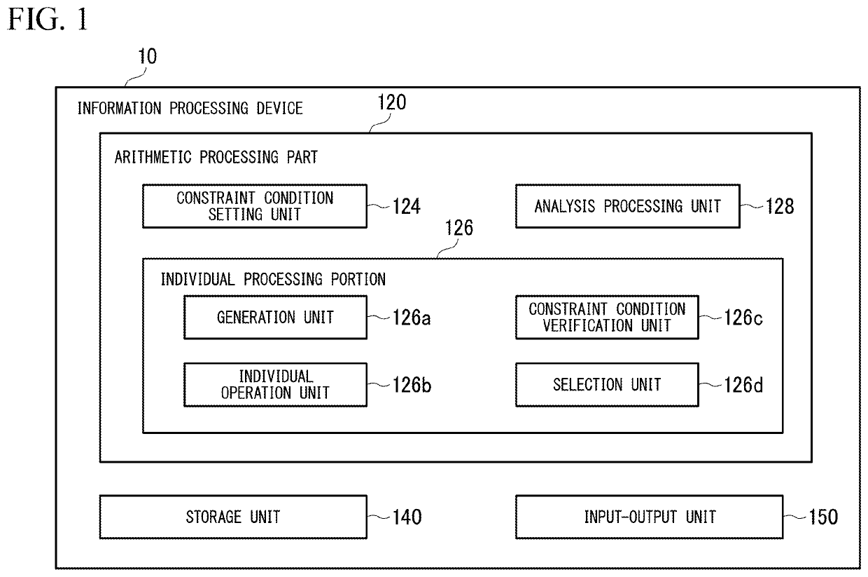

Embodiments of the present application will be described with reference to the drawings. FIG. 1 is a schematic block diagram which shows an example of a functional configuration of an information processing device 10 according to the present embodiment. The information processing device 10 according to the present embodiment acquires product data and stores the acquired product data. The product data includes n individuals (n is a predetermined integer of 2 or more). Each individual constitutes an explanatory variable group having a plurality of explanatory variables representing production conditions of each individual product. Production conditions of a product include product materials, design matters, or the like. The explanatory variable group is used to predict performance of a product produced according to its production conditions. The information processing device 10 calculates a degree of fitness indicating overall performance of the product on the basis of an objective variable. An objective variable is an index of an individual element of performance. The information processing device 10 calculates an objective variable using a learning model for an explanatory variable group.

The information processing device 10 executes processing for solving a multi-objective optimization problem using an evolutionary algorithm on product data. The information processing device 10 executes a crossover process of generating a new individual by changing values of some explanatory variables of an individual selected with a predetermined first probability from current generation product data (hereinafter referred to as “current generation data”) having n individuals to values determined based on values of corresponding explanatory variables of another individual, a mutation process of generating a new individual by changing values of some explanatory variables of an individual selected with a second probability from the current generation data to other values, and a selection process of selecting n individuals of next generation data on the basis of a degree of fitness calculated from an explanatory variable group for each individual from the stored individuals and the generated individuals. Therefore, some individuals for each generation are rejected on the basis of the degree of fitness and replaced with new individuals.

Next, an example of the functional configuration of the information processing device 10 will be described. The information processing device 10 includes an arithmetic processing part 120, a storage unit 140, and an input-output unit 150.

The arithmetic processing part 120 includes a constraint condition setting unit 124, an individual processing portion 126, and an analysis processing unit 128.

The constraint condition setting unit 124 sets constraint conditions to be imposed on a group of explanatory variables forming each individual, and stores constraint condition information indicating the set constraint conditions in the storage unit 140.

Constraint conditions are individual constraint conditions applied to one explanatory variable. Individual constraint conditions mainly define a range of explanatory variables. More specifically, the individual constraint conditions can indicate whether a type of an explanatory variable is a continuous value or a discrete value, and one or both of maximum and minimum possible values are indicated. For discrete values, a plurality of candidate values can be specified instead of the maximum or minimum value. For example, in an individual ev1, individual constraint conditions indicate that types of explanatory variables ev1-1 and ev1-3 are discrete values, and a type of ev1-2 is a continuous value. The explanatory variables ev1-1 and ev1-3 take any one of a plurality of candidate values, and ev1-2 takes a value within a range set as the individual constraint conditions.

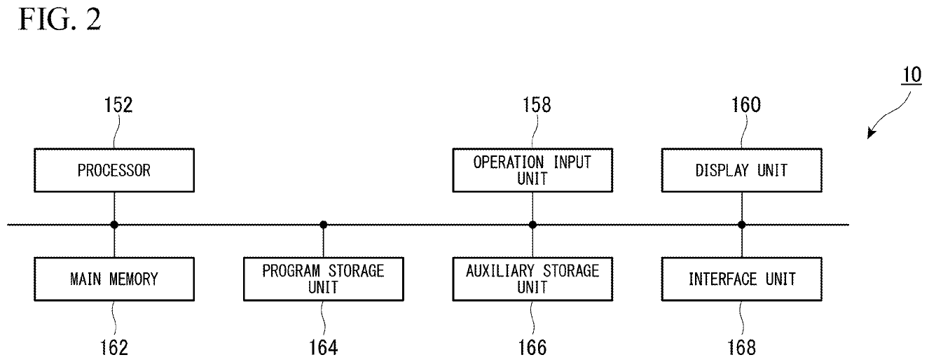

The constraint condition setting unit 124 adds, changes, or deletes various constraint conditions according to, for example, operation information input from an operation input unit 158 (FIG. 2). The constraint condition setting unit 124 may acquire constraint condition information indicating constraint conditions from another device. Note that specific examples of constraint conditions will be described below.

The individual processing portion 126 includes a generation unit 126a, an individual operation unit 126b, a constraint condition verification unit 126c, and a selection unit 126d.

The generation unit 126a reads the constraint condition information stored in the storage unit 140, refers to the read constraint condition information, and specifies the constraint conditions to be applied to each explanatory variable.

The generation unit 126a generates n individuals as initial individuals to satisfy the specified constraint conditions, and configures first generation product data including the generated initial individuals. The generation unit 126a stores the configured product data in the storage unit 140 as first generation data.

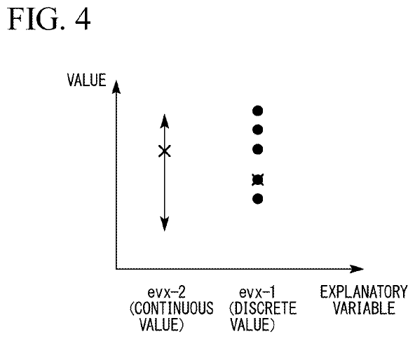

When an initial individual is generated, the generation unit 126a sets values of explanatory variables thereof to satisfy individual constraint conditions imposed on each explanatory variable for explanatory variables constituting each individual. For example, for an explanatory variable that takes a continuous value whose maximum value and minimum value are defined, the generation unit 126a randomly selects one real value within a range between the minimum value and the maximum value as a value of the explanatory variable (refer to FIG. 4). For an explanatory variable that takes a discrete value, the generation unit 126a randomly selects one of a plurality of candidates for possible values as the value of the explanatory variable. Note that, in this application, “randomly” means stochastically, more specifically, determining a value using pseudo-random numbers.

The crossover process includes the following processing of S62 to S68.

(S62) A focus explanatory variable that is part of the explanatory variables of a focus individual to be processed is randomly selected from n parent individuals.

(S64) A reference individual to be referred to is randomly selected from the remaining n−1 parent individuals.

(S66) A first target value is determined for the focus individual on the basis of a value of the focus explanatory variable of the reference individual. Moreover, a second target value is determined for the reference individual on the basis of the value of the focus explanatory variable of the focus individual.

(S68) The value of the focus explanatory variable of the focus individual is replaced with the first target value, and the values of the other explanatory variables are maintained to generate a new individual as a child individual. A new individual is generated as a child individual by replacing the value of the focus explanatory variable of the reference individual with the second target value and maintaining the values of the other explanatory variables.

The individual operation unit 126b repeats the processing of S62 to S68 until the number of child individuals reaches p (p is a predetermined integer greater than 1 and less than n). p/2n corresponds to a crossover rate. The number p of child individuals is set in advance on the basis of the crossover rate in the individual operation units 126b.

Note that, in the processing of S66, a method for determining a target value to be set for the focus explanatory variable differs depending on whether the focus explanatory variable is a continuous value or a discrete value. For example, when the focus explanatory variable is a discrete value, the individual operation unit 126b determines the value of the focus explanatory variable of the reference individual and the value of the focus explanatory variable of the focus individual as the first target value and the second target value, respectively (uniform crossover). When the focus explanatory variable takes a continuous value, the individual operation unit 126b determines the first target value and the second target value using the simulated binary crossover (SBX) method. The SBX method includes a process of setting a predetermined first probability distribution and a predetermined second probability distribution that have centers of gravity at the value of the focus explanatory variable of the reference individual and the value of the focus explanatory variable of the focus individual, and are symmetrical to each other, and a process of randomly determining the first target value according to the first probability distribution, and randomly determining the second target value according to the second probability distribution.

For example, for a focus explanatory variable ev1-2 which is a continuous value, the original value ev1-2 is replaced by the second target value ev2-2′ using a probability density function around the focus explanatory variable ev2-2 of the reference individual ev2 on the basis of the SBX method. For the focus explanatory variable ev1-1, which is a discrete value, the original value ev1-1 is replaced with the second target value ev2-1 in the corresponding focus explanatory variable ev2-1 of the reference individual ev2. An explanatory variable group including the replaced value of the focus explanatory variable and values of the other explanatory variables of the focus individual is generated as a child individual ev1′.

A mutation process includes the following processing of S82 and S84.

(S82) A focus explanatory variable, which is part of the explanatory variables of the focus individual to be processed, is randomly selected from n parent individuals at a predetermined mutation rate.

(S84) A new individual is generated as a child individual by randomly determining a target value of the focus explanatory variable, replacing the original value of the focus explanatory variable with the target value, and maintaining the values of the other explanatory variables.

However, when the focus explanatory variable is a continuous value and the maximum and minimum values are set as individual constraint conditions, a real value of any one of continuous values within the range from the minimum value to the maximum value is set as a target value. When the focus explanatory variable is a discrete value, one candidate value randomly selected from a plurality of candidate values set as individual constraint conditions is determined as the target value.

For example, for a focus explanatory variable ev3-2, which is a continuous value, a real value ev1-2′ within the range from the minimum value to the maximum value, which are set as the individual constraint conditions, is randomly determined as a target value. For the focus explanatory variable ev3-1, which is a discrete value, one candidate ev3-1′ is randomly determined as a target value from a plurality of value candidates set as individual constraint conditions. An explanatory variable group including the replaced value of the focus explanatory variable and the values of other explanatory variables is generated as a child individual ev3′.

The selection unit 126d calculates the degree of fitness of respective individuals constituting the current generation data using a predetermined mathematical model. An index indicating performance of a product is applied as the degree of fitness. The selection unit 126d selects n individuals from n parent individuals and newly generated child individuals in descending order of the degree of fitness, that is, by prioritizing individuals with a degree of fitness that gives good performance. The selection unit 126d stores next generation data including the selected n individuals in the storage unit 140.

Product performance is generally evaluated using a plurality of factors. For example, when the product is a battery, an index that quantitatively indicates a capacity, an output, cost, and the like can be an element. The capacitance corresponds to a charge that is discharged from when discharge starts until an end voltage is reached when an output voltage between two poles is a rated voltage. An output corresponds to a current or power obtained by performing discharge when an output voltage is equal to the rated voltage. Cost is cost of manufacturing the product. The cost may include various expenses required for processing, distribution, and the like, in addition to a unit price of each individual member.

An individual element may be applied as the degree of fitness, or an index that combines a plurality of elements may be applied. A function that calculates the degree of fitness by integrating element indices related to the plurality of elements may be a function that monotonically changes to a value that indicates better performance when it changes to a numeral value that indicates good performance for each element. For example, the selection unit 126d can calculate an element index ak using a learning model that has been learned for each element type k from an explanatory variable group of each individual, and calculate a weighted sum of the calculated element index ak between element types k as the degree of fitness. In model learning, a parameter set of the learning model is determined in advance so that a predicted value of a target variable calculated using a learning model from a known explanatory variable group for each element type k and a target value of a target variable corresponding to the explanatory variable group are approximated as an entire training data.

As a learning model, for example, any one of a linear model learned using multiple regression analysis, ridge regression, least absolute shrinkage and selection operator (LASSO) regression, an elastic net, and the like, and a non-linear model such as a support vector machine, a neural network, adaboost, or random forest may be used. In addition, a different learning model may be used for each element type k. A weighting coefficient wₖ used for calculating the degree of fitness is set in advance in the selection unit 126d.

The analysis processing unit 128 selects one or a plurality of types of individuals on the basis of the degree of fitness calculated from the explanatory variable group among the individuals forming the product data stored in the storage unit 140. The analysis processing unit 128 configures a display screen, for example, by associating an explanatory variable group of the selected individual and the degree of fitness, and outputs display data indicating the configured display screen to the display unit 160 (FIG. 2). The analysis processing unit 128 may include the element index calculated from the explanatory variable group in the display screen in association with the explanatory variable group or the degree of fitness.

The analysis processing unit 128 may also evaluate growth potential of the n parent individuals as a whole for each generation. An optimal value of the degree of fitness between individuals (hereinafter sometimes referred to as an “optimal degree of fitness”) and a degree of discreteness are included as statistics for an index of growth potential (hereinafter sometimes referred to as a “growth index value”). The degree of discreteness is a degree to which a group of explanatory variables are randomly distributed over an entire vector space instead of being concentrated around a particular value. As an index indicating the degree of discreteness, for example, any of a variance between individuals, an average distance between individuals, and the like may be used. Generally, as an aggregation of individuals grows normally, the growth index value tends to increase and a growth rate, that is, an amount of change thereof, tends to decrease. The analysis processing unit 128 may output display data indicating a display screen including the growth index value to the display unit 160.

The storage unit 140 stores various data temporarily or permanently.

The input-output unit 150 allows various input data to be input to or output from other devices.

Note that instead of outputting various display data to the display unit 160, the analysis processing unit 128 may output them to other devices via the input-output unit 150.

The constraint condition setting unit 124 and the individual processing portion 126 may receive various types of operation information from other devices via the input-output unit 150 instead of receiving them from the operation input unit 158. Other devices may be connected via a communication network.

Next, an example of a hardware configuration of the information processing device 10 according to the present embodiment will be described. FIG. 2 is a schematic block diagram which shows an example of a hardware configuration of the information processing device 10 according to the present embodiment. The information processing device 10 includes a processor 152, an operation input unit 158, a display unit 160, a main memory 162, a program storage unit 164, an auxiliary storage unit 166, and an interface part 168. The processor 152, the operation input unit 158, the display unit 160, the main memory 162, the program storage unit 164, the auxiliary storage unit 166, and the interface part 168 are connected by a bus, and are capable of inputting and outputting various data to and from each other.

The processor 152 executes arithmetic processing instructed by a command written in various programs. The processor 152 controls an overall operation of the information processing device 10. The processor 152 is, for example, a central processing unit (CPU). In this application, executing arithmetic processing instructed by a command written in a program is sometimes referred to as “executing the program”.

The operation input unit 158 is capable of receiving an operation, and generates an operation signal according to the received operation. Various types of operation information are instructed by an operation signal. The operation input unit 158 may include general-purpose members such as a mouse, a touch sensor, and a keyboard, or may include dedicated members such as buttons and dials.

The display unit 160 displays a display screen according to display data input to the display unit 160. The display unit 160 may be one of a liquid crystal display, an organic electroluminescent display, and the like.

The main memory 162 is a writable memory used as a reading area for an execution program of the processor 152 or as a work area for writing processing data of the execution program. The main memory 162 is configured to include, for example, a random access memory (RAM).

The program storage unit 164 stores system firmware such as a basic input output system (BIOS), firmware for various devices, other programs, and setting information required for execution of these programs. The program storage unit 164 includes, for example, a read only memory (ROM).

The auxiliary storage unit 166 permanently stores various data and programs in a rewritable manner. The auxiliary storage unit 166 may be, for example, a hard disk drive (HDD), a solid-state storage device (SSD), or the like.

The interface part 168 connects to other devices by wire or wirelessly so that various data can be input and output. The interface part 168 includes one or both of an input or output interface and a communication interface.

The processor 152 and the main memory 162 correspond to minimum hardware used to realize a computer system of the information processing device 10. The processor 152 mainly realizes functions of the arithmetic processing part 120 by executing a predetermined program in cooperation with the main memory 162 and other hardware. The main memory 162, the program storage unit 164, and the auxiliary storage unit 166 realize a main function of the storage unit 140. The interface part 168 realizes a main function of the input-output unit 150.

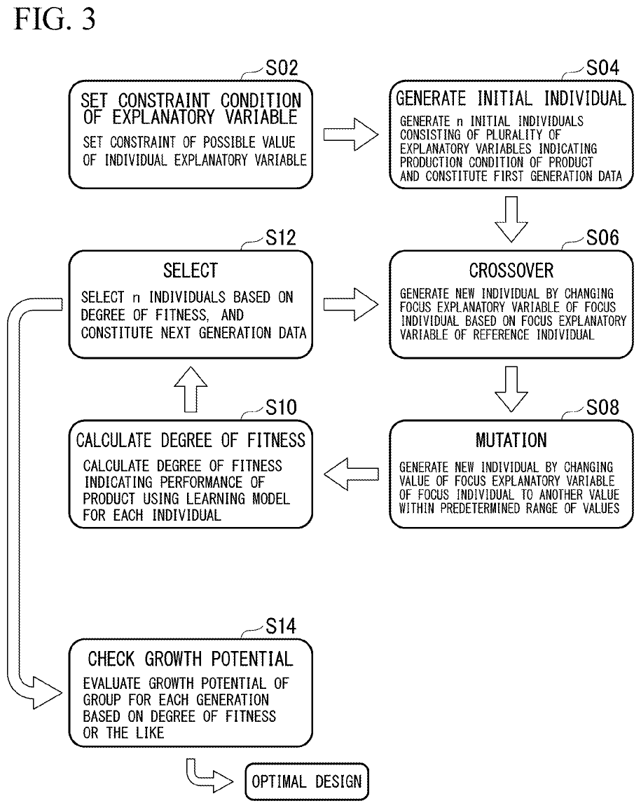

Next, an example of information processing according to the present embodiment will be described. FIG. 3 is an overhead view which exemplifies information processing according to the present embodiment.

(Step S02) The constraint condition setting unit 124 sets individual constraint conditions applied to individual explanatory variables as constraint conditions imposed on an explanatory variable group.

(Step S04) The generation unit 126a generates n initial individuals consisting of a plurality of explanatory variables indicating production conditions of a product. The constraint condition verification unit 126c verifies that all of the generated initial individuals satisfy the set constraint conditions. The generation unit 126a configures first generation data including n initial individuals that satisfy the constraint conditions as parent individuals, and stores it in the storage unit 140.

The individual processing portion 126 repeats the processing of steps S06 to S12 G times. G is an integer of 2 or more indicating the predetermined number of generations.

(Step S06) The individual operation unit 126b repeatedly executes the crossover process according to a predetermined crossover rate. The individual operation unit 126b randomly selects the focus explanatory variable of the focus individual from the parent individuals in the crossover process. The individual operation unit 126b generates a new individual by changing a value of the focus explanatory variable of the focus individual to a target value based on the value of the focus explanatory variable of a randomly selected reference individual. The individual operation unit 126b includes the new individual as a child individual in the current generation data.

(Step S08) The individual operation unit 126b repeatedly executes the mutation process according to a predetermined mutation rate. In the mutation process, the individual operation unit 126b randomly selects the focus explanatory variable of the focus individual from the parent individual according to the mutation rate. The individual operation unit 126b generates a new individual as a child individual by changing the value of the focus explanatory variable of the focus individual to a randomly selected target value within a range of values forming the individual constraint conditions of the focus explanatory variable. The individual operation unit 126b includes the new individual as a child individual in the current generation data.

(Step S10) The selection unit 126d calculates the degree of fitness indicating the performance of a product for each individual included in the current generation data.

(Step S12) The selection unit 126d selects n individuals in descending order of performance indicated by the degree of fitness, configures next generation data including the selected n individuals, and stores it in the storage unit 140. After that, the processing returns to step S06.

(Step S14) The analysis processing unit 128 evaluates growth potential of a group on the basis of the degree of fitness of each individual for each generation. For example, the analysis processing unit 128 calculates the optimal degree of fitness as a growth index value on the basis of the degree of fitness of n individuals for each generation.

After the processing of steps S06 to S12 are repeated G times, the analysis processing unit 128 selects one or a predetermined number of individuals in descending order of the degree of fitness, and outputs optimal design information which shows production conditions indicated by explanatory variable groups forming the selected individuals to the display unit 160 or another device.

Note that regardless of whether the number of generations G is set, the analysis processing unit 128 may determine whether a growth of the product data has converged on the basis of the growth index value. For example, the analysis processing unit 128 can determine whether a growth of the product data has converged depending on whether the amount of change in the growth index value between generations decreases monotonically as the generations accumulate, and the amount of change becomes smaller than a predetermined threshold of the amount of change. The analysis processing unit 128 may stop processing in steps S06 to S12 when it is determined that the growth has converged.

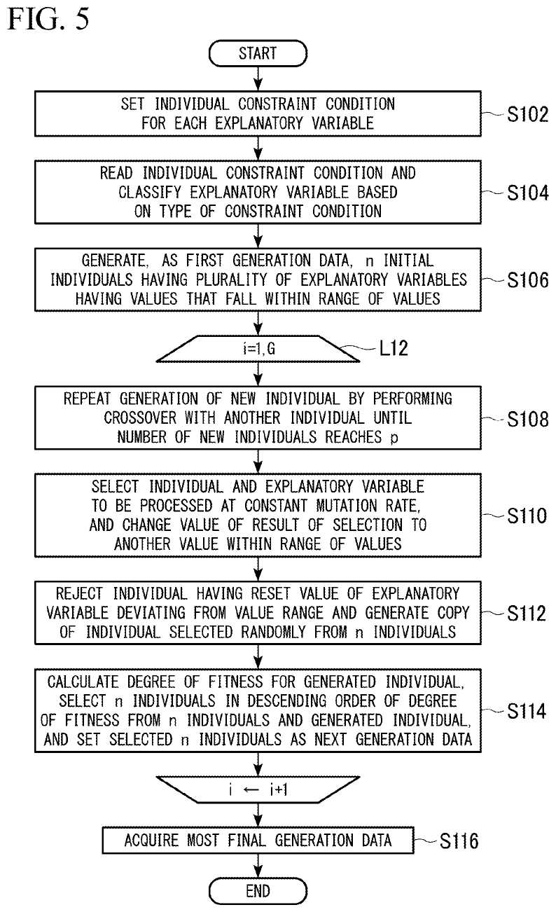

Next, another example of the information processing according to the present embodiment will be described. FIG. 5 is a flowchart which shows another example of the information processing according to the present embodiment. The illustrated example mainly describes generation of an individual and processing for explanatory variables.

(Step S102) The constraint condition setting unit 124 sets individual constraint conditions for each explanatory variable as constraint conditions. The constraint condition setting unit 124 stores constraint condition information indicating the set constraint conditions in the storage unit 140.

(Step S104) The generation unit 126a reads individual constraint conditions from the storage unit 140. The generation unit 126a identifies explanatory variables to which individual constraint conditions are applied, and classifies individual explanatory variables based on a type of constraint conditions.

(Step S106) The generation unit 126a repeats processing of setting the value of the explanatory variable so that it falls within a range specified by the individual constraint conditions, and generates n initial individuals. The generation unit 126a configures first generation data including the generated n initial individuals and stores it in the storage unit 140.

Processing of loop L12 includes the processing of steps S108 to S114, and these pieces of processing are repeated G times. An initial value of the number of repetitions i is set to 1, and the individual processing portion 126 counts the number of repetitions i by adding (incrementing) 1 to the number of repetitions i after processing in step S114 is completed. When the number of repetitions i exceeds G times, processing advances to step S116.

(Step S108) The individual operation unit 126b randomly selects the focus individual to be processed by executing the crossover process, and repeats processing of generating a new individual by crossing it with other reference individuals until the number of new individuals reaches p.

(Step S110) The individual operation unit 126b randomly selects the focus explanatory variable of the focus individual to be processed at a constant mutation rate, changes the value of the focus explanatory variable to a target value, which is in a range of values forming the individual constraint conditions, and generates a new individual.

(Step S112) The constraint condition verification unit 126c rejects an individual whose reset values deviate from the set range of values. The constraint condition verification unit 126c randomly selects each one individual from the n individuals that are parent individuals in place of each rejected individual. The constraint condition verification unit 126c generates a copy of the selected individual as a new individual, and stores it in the current generation data.

(Step S114) The selection unit 126d refers to the current generation data and calculates the degree of fitness for each child individual, which is a newly generated individual, using a predetermined mathematical model from the explanatory variable group. The selection unit 126d selects n individuals in descending order of the degree of fitness from the n parent individuals and the new child individuals, and stores next generation data including the selected n individuals in the storage unit 140.

(Step S116) The analysis processing unit 128 reads the most final generation data stored in the storage unit 140, and selects one or more predetermined number of individuals from the read most final generation data in descending order of the degree of fitness. The analysis processing unit 128 can determine the production conditions shown in the explanatory variable group of the selected individual as optimal design conditions. Thereafter, processing of FIG. 5 ends.

In the description above, a case where in the information processing device 10, the operation input unit 158 and the display unit 160 are connected by wire or wirelessly, operation information is input from the operation input unit 158, and display data is output to the display unit 160 is taken as an example, but the present invention is not limited to this. An input source of the operation information and an output destination of the display data may be an external device connected using a network. In that case, in the information processing device 10, one or both of the operation input unit 158 and the display unit 160 may be omitted.

Although a mode for implementing the present invention has been described above using embodiments, the present invention is not limited to these embodiments in any way, and various modifications and substitutions can be added within a range not departing from the gist of the present invention.

What is claimed is:

1. An information processing method executed by an information processing device, the information processing method comprising:
generating a new individual by changing a value of part of explanatory variables of an individual selected with a first probability from current generation data, which has n individuals (n is an integer of two or more) and in which each individual is an explanatory variable group having a plurality of explanatory variables, to a target value based on a value of a corresponding explanatory variable of another individual;
generating a new individual by changing a value of part of explanatory variables of an individual selected with a second probability from the current generation data to another value; and
selecting n individuals of next generation data from the n individuals and the generated individual based on a degree of fitness calculated from an explanatory variable group for each individual,
wherein the explanatory variable is set to take a value within a predetermined range determined in advance.

2. The information processing method according to claim 1,
wherein the explanatory variable takes a value within a set range when the explanatory variable is a continuous value, and the explanatory variable takes one of a plurality of candidate values when the explanatory variable is a discrete value.

3. A computer-readable storage medium that stores a computer program for causing a computer of an information processing device to execute the information processing method according to claim 1.

4. An information processing device comprising:
a storage portion configured to store current generation data which has n individuals (n is an integer of two or more) and in which each individual is an explanatory variable group having a plurality of explanatory variables; and
an individual processing portion configured to
generate a new individual by changing a value of part of explanatory variables of an individual selected with a first probability from the current generation data to a target value based on a value of a corresponding explanatory variable of another individual,
generate a new individual by changing a value of part of explanatory variables of an individual selected with a second probability from the current generation data to another value, and
select n individuals of next generation data from the n individuals and the generated individual based on a degree of fitness calculated from an explanatory variable group for each individual,
wherein the explanatory variable is set to take a value within a predetermined range determined in advance.
